(19) United States
(12) Patent Application Publication
(10) Pub. No.: US 2018/0159431 A1
(43) Pub. Date: Jun. 7, 2018

(54) FREE PROGRAMMABLE POWER SUPPLY ARRAY

(71) Applicant: INTERNATIONAL BUSINESS MACHINES CORPORATION, Armonk, NY (US)

(72) Inventors: Thomas J. Brunschwiler, Rueschlikon (CH); Arvind Raj Sridhar, Rueschlikon (CH); Jochen Supper, Boeblingen (DE); Klaus Thumm, Boeblingen (DE); Volker Trost, Boeblingen (DE)

(21) Appl. No.: 15/367,788

(22) Filed: Dec. 2, 2016

(51) Int. Cl. H02M 3/335; H02M 1/14

(52) U.S. Cl. CPC H02M 3/33523; H02M 1/14

(57) ABSTRACT

An integrated circuit module including at least one semiconductor chip. The at least one semiconductor chip includes a plurality of voltage converters and switching circuitry for connecting an input terminal of one of the plurality of voltage converters to an input power supply rail and an output terminal of at least one of the plurality of voltage converters to an output supply rail. The switching circuitry is, dependent on at least one input signal, operable for selectively establishing for at least two of the plurality of voltage converters one out of the group including a parallel connection of the at least two voltage converters, a serially cascaded connection of the at least two voltage converters, and a stacked serial connection of the at least two voltage converters.

### BACKGROUND

One or more aspects of the invention relate generally to an integrated circuit module, and more specifically, to flexible power supplies.

The increasing complexity of electronic systems also increases the requirement for flexible power supplies in terms of voltage and current. The electronic systems may require power provided at several different discrete voltage and current levels, and thus, power levels. Sometimes, the electronic systems or parts thereof are operated in an idle mode or a sleep mode requiring much less power than in normal or extended operation mode. Typically, switching power supplies are used to provide power to the electronic systems. However, typical switching power supplies are designed to provide fixed voltage levels operable up to a maximum current. There is little flexibility in terms of switchable voltage levels which may be configured dynamically to support dynamically changing power requirements of, e.g., high performance computing cores of enterprise computing systems.

### SUMMARY

According to one aspect of the present invention, an integrated circuit module may be provided. It may include at least one semiconductor chip. The semiconductor chip may include a plurality of voltage converters and switching circuitry for connecting an input terminal of one voltage converter of the plurality of the voltage converters to an input power supply rail and an output terminal of at least one voltage converter of the plurality of voltage converters to an output power supply rail.

The switching circuitry may be, dependent on at least one input signal, operable for selectively establishing for at least two of the plurality of voltage converters, one connection selected from the group consisting of: a parallel connection of the at least two voltage converters, a serially cascaded connection of the at least two voltage converters and, a stacked serial connection of the at least two voltage converters.

Additional features and advantages are realized through the techniques described herein. Other embodiments and aspects are described in detail herein and are considered a part of the claimed aspects.

### BRIEF DESCRIPTION OF THE DRAWINGS

It should be noted that embodiments of the invention may be described with reference to different subject matters. In particular, some embodiments may be described with reference to method type claims whereas other embodiments may be described with reference to apparatus type claims. However, a person skilled in the art will gather from the above and the following description that, unless otherwise notified, in addition to any combination of features belonging to one type of subject matter, also any combination between features relating to different subject matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which aspects of the invention are not limited.

Embodiments of the invention will be described, by way of example only, and with reference to the following drawings:

FIGS. 1A and 1B each shows a block diagram of possible embodiments of an integrated circuit module in two configurations, in accordance with aspects of the present invention;

FIG. 2 shows a block diagram of an embodiment of a power supply, in accordance with an aspect of the present invention;

FIG. 3 shows a block diagram of an embodiment of a power supply with a galvanic separation, in accordance with an aspect of the present invention;

FIG. 4 shows an embodiment of a stacked serial configuration of power supplies, in accordance with an aspect of the present invention;

FIG. 5 shows an embodiment of a matrix of power converters, in accordance with an aspect of the present invention;

FIG. 6 shows an embodiment of circuitry adapted for connecting the power supplies in different configurations between an input voltage and one or more output voltages, in accordance with an aspect of the present invention; and

FIG. 7 shows an overview diagram of the integrated circuit module comprising at least one semiconductor chip, in accordance with an aspect of the present invention.

### DETAILED DESCRIPTION

In the context of this description, the following conventions, terms and/or expressions may be used:

The term ‘voltage converters’ may denote electronic circuitry for transforming electrical power from a source to a destination or, from a power input to a power output. The transformation may be done upwards or downward in terms of voltage. In the simplest case, a transformer may be used. Other voltage converters use the transformer together with electronic circuitry. Again other voltage converters are implemented as switching voltage converters. In one case, the voltage converter may be a buck converter or step-down converter performing a DC-to-DC power converter which steps down voltage (while stepping up current) from its input (supply) to its output (load). It is a class of switched-mode power supply (SMPS) typically comprising at least two semiconductors (a diode and a transistor, although modern buck converters frequently replace the diode with a second transistor used for synchronous rectification) and at least one energy storage element, a capacitor, an inductor, or the two in combination. To reduce voltage ripple, filters made of capacitors (sometimes in combination with inductors) are added to such a converter's output (load-side filter) and input (supply-side filter). A voltage converter may in the context of this document also be denoted as a power supply.

The term ‘switching mode power converter’ may be used in the sense of the just-detailed voltage converter explanation.

The term ‘galvanic separation’ may denote that an input or primary circuitry of a voltage converter is electrically isolated from an output or secondary circuitry of the voltage converter. Thus, there is no common ground between the input stage and the output stage. Typically, this galvanic separation is achieved by a transformer between the primary and the secondary circuitry.

The term ‘serially cascaded connection’ may denote that a plurality of power supplies may be connected in such a way that their input lines are connected in series.

The term ‘stacked serial connection’ may denote that the output voltages of the power supplies or voltage converters are connected in series. Thus, only one total output voltage is delivered from the combination of the power supplies. On the other side, the input lines of the plurality of voltage converters may be connected in parallel. However, this is possible if the voltage converters are of the type that separates the input stage and the output stage galvanically. Otherwise a short cut may be provoked.

The integrated circuit module of one or more aspects of the present invention may offer multiple advantages and technical effects:

One or more aspects allow a high degree of flexibility in terms of combination of power supplies, allowing dynamically reconfiguring and rearranging power supplies as required. The power supply may dynamically be adapted in terms of current, voltage, efficiency, ripple and other typical power supply parameters. The adaptability of the power supplies may support changing workload requirements of electronic systems even during the runtime of the electronic systems. Even if the electronic systems or their computing cores may be exchanged while—at the same time—continuing using the power supplies, the here proposed flexibility of combinations of power supplies may allow to use them also with a new generation of supported electronic systems. Additionally, a comparably easy isolation of power supply failures may be supportable. Thus, an easy root cause analysis in the power supply system is designable into the here proposed modules.

In the following, additional embodiments of the integrated circuit module are described.

According to one optional embodiment of the integrated circuit module, the module may comprise at least one passive component. Moreover, the switching circuitry may be operable for connecting the at least one passive component to one of the plurality of voltage converters selected by a control signal provided to the switching circuitry. The passive component may be an electrical load which the voltage converter supplies electrical energy to or, it may be part of an extended voltage converter to reduce a ripple on the output voltage or, optimize the output power levels in another way. In this sense and according to one permissive embodiment of the integrated circuit module, the at least one passive component may be at least one of an inductor or a capacitor. Other passive elements may also be usable, like a resistor and/or also semiconductors operating in a passive mode.

According to one embodiment of the integrated circuit module, the at least one of the plurality of voltage converters may be a switching mode power converter. This way up and down conversion may be possible. Additionally, switching power supplies may be implemented more compact in comparison to traditional transformer based voltage converters. Thus, in one embodiment of the integrated circuit module, the at least one switching mode power converter may be a buck converter.

According to one embodiment of the integrated circuit module, the at least one of the plurality of voltage converters may be a switching mode power converter comprising a galvanic separation between a primary stage and a secondary stage circuit of the voltage converter. Using the galvanic separation, an embodiment of the stacked serial type may be enabled.

According to another embodiment of the integrated circuit module, the switching elements of the switching circuitry may be arranged in a two-dimensional matrix. The matrix may comprise row conductors and column conductors. The row conductors may be connected to the input power rail and the column conductors may be connected to output power rails or vice versa. Such a matrix may allow a fully flexible way to connect the power supplies or voltage converters to input and output rails. All sorts of parallel, stacked serial and serial cascaded configurations of a plurality of power supplies or voltage converters become possible, depending on how the power supplies may be connected to the row conductors and the column conductors.

According to one embodiment of the integrated circuit module, the integrated circuit module may be a single chip module comprising a single semiconductor chip or a multi-chip module, which may comprise multiple semiconductor chips. Thus, the designer has full flexibility in integrating the integrated circuit module into existing electric and electronic environments.

According to a further embodiment of the integrated circuit module, the primary stage of at least one of the plurality of voltage converters may be implemented as a half-bridge or as a full-bridge circuit. The same may apply to the secondary stage of at least one of the plurality of voltage converters. Also here, a half-bridge or a full-bridge circuit may be used. In other embodiments, also a single switching element may be used instead of two or four for a half-bridge or full-bridge implementation. As understood by a skilled person, a full-bridge implementation may have a higher efficiency factor if compared to a half-bridge implementation as well as a lower ripple effect on the output voltage of the power supply. The same effect may be observed if comparing a half-bridge implementation in comparison to an implementation with only one switching element.

In the following, a detailed description of the figures will be given. All instructions in the figures are schematic. Firstly, a block diagram of an embodiment of an integrated circuit module, in accordance with an aspect of the present invention, is given. Afterwards, further embodiments, as well as embodiments, of a Free Programmable Power Supply array will be described.

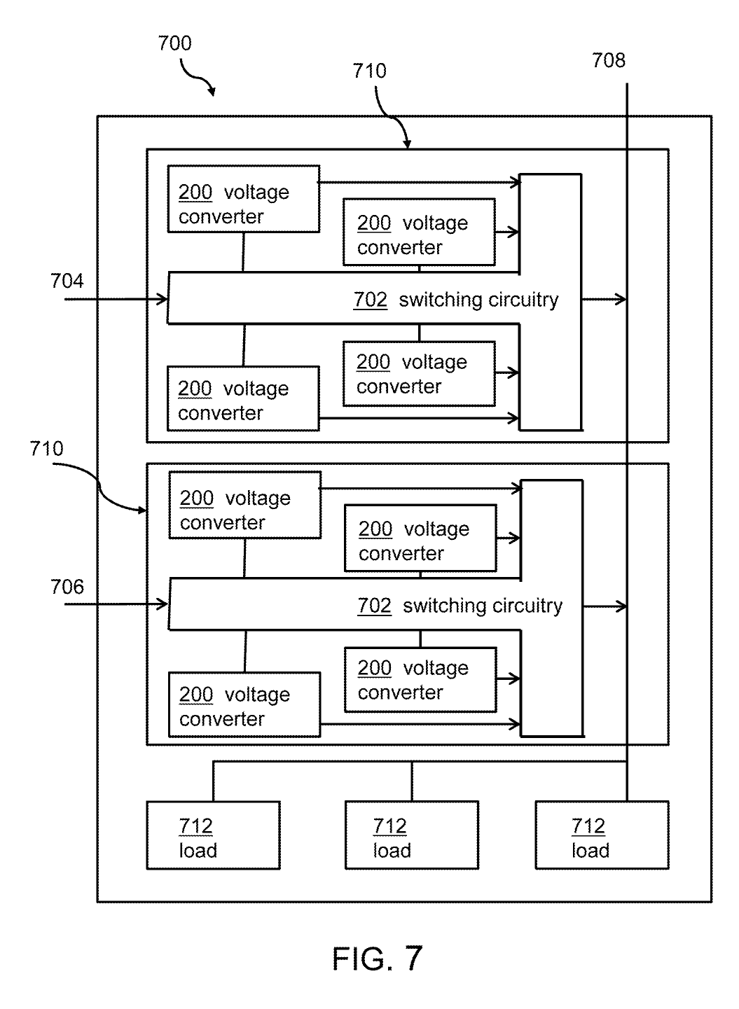

FIG. 7 shows one example of a block diagram of an integrated circuit module 700 comprising at least one semiconductor chip 710. Each semiconductor chip 710 (two are shown) comprises a plurality of voltage converters 200, and switching circuitry 702 for connecting an input terminal (not shown) of one of the plurality of the voltage converters to an input power supply rail (not shown) and an output terminal of at least one of the plurality of voltage converters to an output supply rail 708.

Dependent on at least one input signal 704, 706, switching circuitry 702 is operable for selectively establishing for at least two of the plurality of voltage converters 200 a parallel connection of the at least two voltage converters 200 or, a serially cascaded connection of the at least two voltage converters 200, or a stacked serial connection of the at least two voltage converters 200.

Additionally, FIG. 7 shows example loads 712 as part of integrated circuit module 700. These may be circuitry blocks of electronic components requiring power from the voltage converter(s) 200. In an embodiment, a load 712 may be a logic circuit, a processor core, interconnect circuitry for interconnecting processor cores and other circuits with each other, external interface logic, etc. Beside these elements, the integrated circuit module 700 may also comprise a plurality of passive circuitry elements, like resistors, capacitors or inductors, e.g., in an integrated or printed form or as a discrete device.

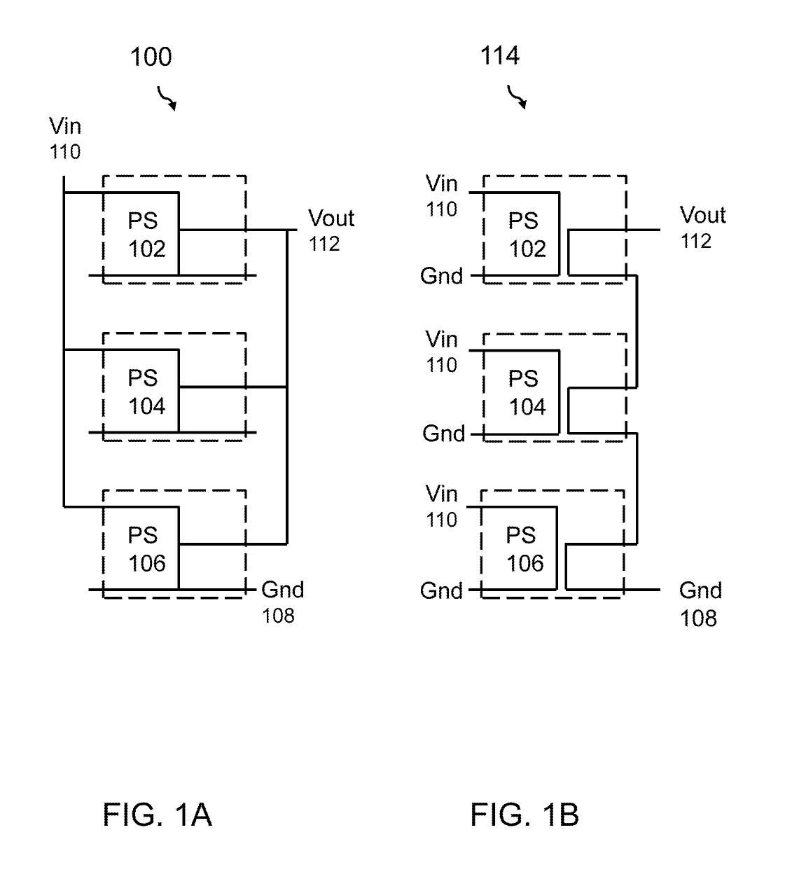

FIG. 1A and FIG. 1B each shows one of possible configurations 100, 114 of an integrated circuit module, in accordance with an aspect of the present invention. FIG. 1A shows a parallel connection 100 of power supplies (PS) 102, 104 and 106. They have a common voltage input terminal Vin 110, a common voltage output terminal Vout 112 and a common ground Gnd 108.

For this configuration, in one example, the following parameters are applicable:

Vinmax=Vinmaxᵢ

Voutmax=Voutmaxᵢ

Vin/Vout=(Vin/Vout)ᵢ

Ioutmax=n*Ioutmaxᵢ,

wherein—in the context of the power supply—Vinmax is the maximum input voltage for one of the power supplies i, Voutmax is the maximum output voltage of the joint circuitry, Voutmaxᵢ is the maximum output voltage of a single power supply i. The maximum current output Ioutmax equals the maximum current of one of the power supplies i times the number of power supplies assumed that the power supplies have comparable characteristics.

FIG. 1B shows a stacked serial implementation 114 of aspects of the present invention, in which the output voltage Vout 112 is the sum of the output voltages of the single power supplies 102, 104 and 106.

For the configuration according to FIG. 1B, the following parameters are applicable:

Vinmax=Vinmaxᵢ

Voutmax=n*Voutmaxᵢ

Vin/Vout=(Vin/Vout)ᵢ

Ioutmax=Ioutmaxᵢ.

Thus, this configuration may deliver an increased voltage in contrast to the configuration according to FIG. 1A which is designed to deliver a higher output current Ioutmax if compared to the serially stacked individual power supplies 102, 104 and 106.

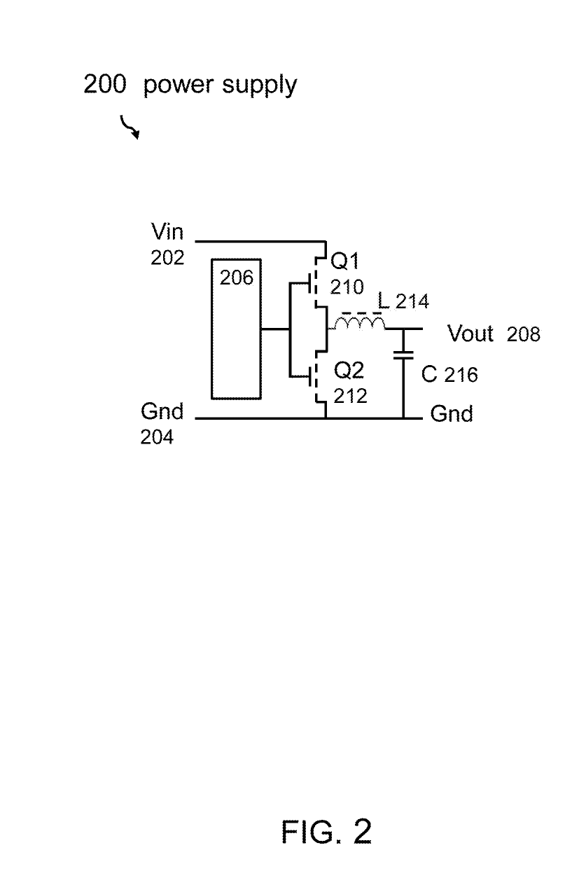

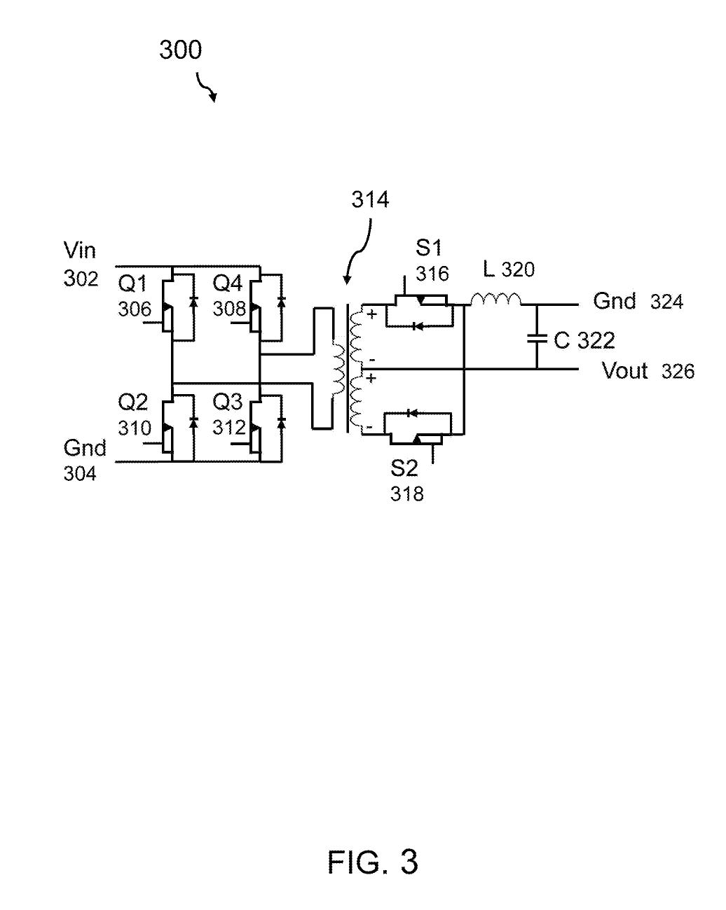

It may be noted that the power supplies 102, 104 and 106 are only shown schematically. They are more detailed in FIG. 2 and FIG. 3.

One possible implementation of one individual of the power supplies 102, 104, 106 of FIG. 1A or FIG. 1B is shown in FIG. 2. Other implementation options are available. However, in this case, a pulse wide modulation (PWM) circuit 206 controls the operation of the two switches Q1 210 and Q2 212 in order to transform the voltage Vin 202 to the output voltage Vout 208 using a common ground Gnd 204. In order to operate as energy storage and to smooth out the output voltage and reduce the ripple, the inductor L 214 and the capacitor C 216 are used as shown in the circuitry 200.

In order to implement the configuration of FIG. 1B, the input stage and the output stage of any of the power supplies 102, 104, 106 are isolated galvanically. Thus, the input circuitry and the output circuitry of the power supply do not use a common ground. This is shown in FIG. 3, as one example. Input Gnd 304 and output Gnd 324 are separated from each other. The power supply 300 is transforming the input voltage Vin 302 to the output voltage Vout 326. On the input side, a full bridge circuitry comprising the switches Q1 306, Q2 310, Q4 308, Q3 312 is used. In parallel to the switches of the full-bridge circuitry, free-wheeling diodes are shown (without reference numerals). The input lines of the switches 306, 308, 310, 312 may typically be connected to a PWM circuitry. The just described primary circuitry is connected to the prime coil of transformer 314. The secondary side of the transformer 314 has two coils. They are connected to a half bridge circuitry comprising switches S1 316 and S2 318 as known by a skilled person. Also, in one example, free-wheeling diodes are used. The output side of the power supply also comprises the inductor L 320 and the capacitor C 322 as usual.

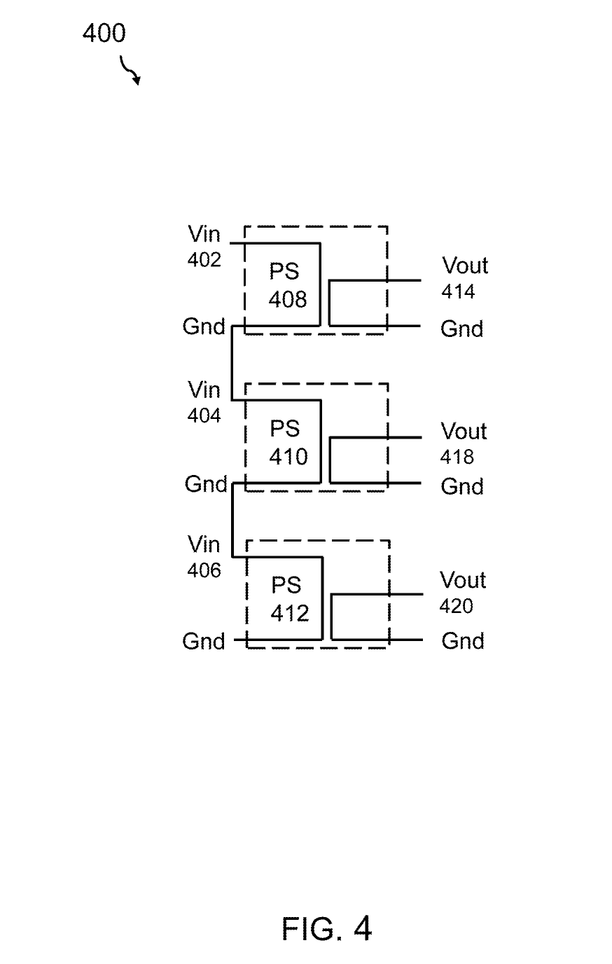

FIG. 4 shows another configuration 400 of the serially stacked type. In this embodiment, the input side of the power supplies 408, 410, 412 are connected in series allowing increased voltage dynamics. Here, the following parameters are applicable, in one example:

Vinmax=n*Vinmaxᵢ

Voutmax=Voutmaxᵢ

Vin/Vout=(Vin/Vout)ᵢ

Ioutmax=Ioutmaxᵢ.

Thus, this configuration allows independent output voltages if no common ground is used, because galvanically separated power supplies 408, 410, 412 are used. As shown, the input ground Gnd of power supply 408 is connected to the input voltage terminal Vin 404 of the second power supply 410, and the input ground Gnd of power supply 410 is connected to the input voltage terminal Vin 406 of the power supply 412. Thus, one input voltage Vin 402 is used to generate three output voltages Vout 414, 418, 420. At least two power supplies are used for such a configuration; on the other side, an indefinite number of power supplies may be serially cascaded.

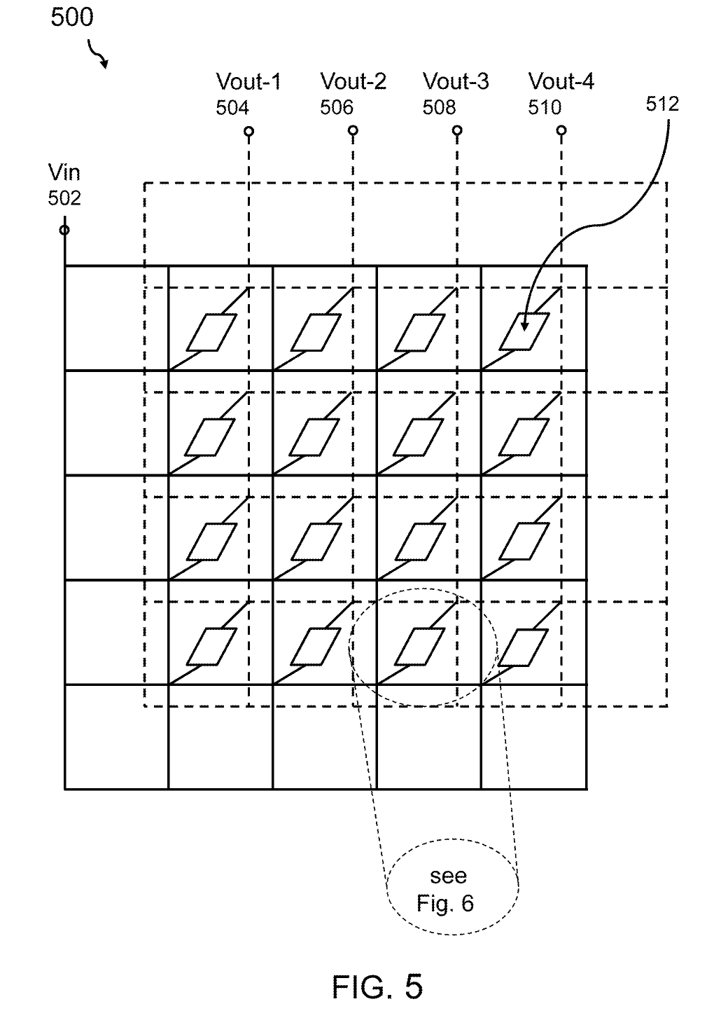

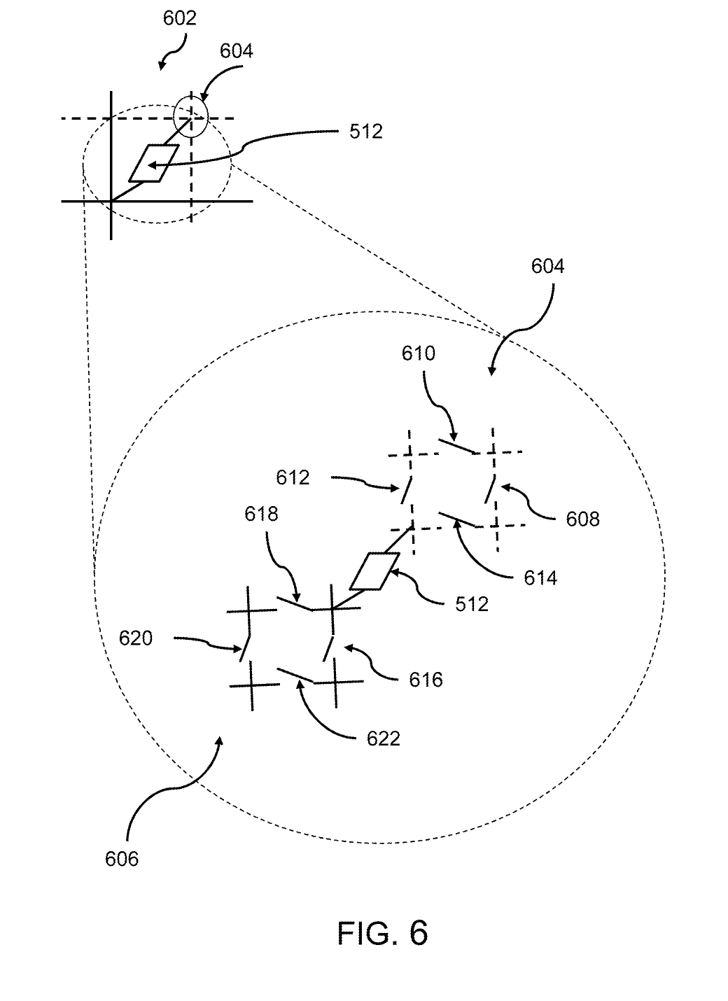

FIG. 5 shows an advanced configuration of a matrix 500 of power supplies 512, referred to herein as a Free Programmable Power Supply Array. The matrix or grid uses a common input voltage Vin 502 and several output voltages Vout-1 504, Vout-2 506 Vout-3 508 Vout-4 510. Clearly, a different number of rows and columns of the matrix than shown is possible. Each one of the power supplies 512 is connected to a crossing point of the input voltage rows 502 and the output voltage column lines in a manner shown in detail in FIG. 6. It may be noted, that the input voltage lines Vin 502 are shown as non-dashed lines, whereas the output voltage lines are shown as dashed lines.

FIG. 6 shows a detailed individual power supply 512 of FIG. 5 with related circuitry 602. The connection of each of the power supplies 512 is magnified in the larger dashed circle. The connection 604 (small circle) of the power supply 512 to the dashed output voltage lines is achieved by a first network of switches 608, 610, 612 and 614. On the other side, the power supply 512 is connected to the non-dashed input lines by a second network 606 of switches 616, 618, 620 and 622. This way, a completely flexible configuration in the matrix of power supplies 512 is given. It is highly flexible and adaptable to a large variety of power requirements in a fast changing environment of electronic components. The complete matrix can be reconfigured at any time. No manual connections or disconnections of plugs or cables may be required.

It may be noted that trigger signals for controlling the first network of switches and the second network of switches have to ensure that no shortcuts are produced in the matrix. A corresponding control circuitry may be used.

Described herein is an approach to design more flexible power supplies. As an example, a flexible power supply with dynamically adjustable voltage and current levels, e.g., as a single module, is provided in one or more aspects.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. An integrated circuit module comprising:
at least one semiconductor chip, the semiconductor chip comprising:
a plurality of voltage converters; and
switching circuitry for connecting an input terminal of one voltage converter of the plurality of voltage converters to an input power supply rail, and an output power terminal of at least one voltage converter of the plurality of voltage converters to an output power supply rail, wherein the switching circuitry is, dependent on at least one input signal, operable for selectively establishing for at least two voltage converters of the plurality of voltage converters one connection selected from the group consisting of: a parallel connection of the at least two voltage converters, a serially cascaded connection of the at least two voltage converters, and a stacked serial connection of the at least two voltage converters.

2. The integrated circuit module according to claim 1, further comprising at least one passive component, wherein the switching circuitry is operable for connecting the at least one passive component to a selected voltage converter of the plurality of voltage converters selected by a control signal provided to the switching circuitry.

3. The integrated circuit module according to claim 2, wherein the at least one passive component is at least one of an inductor or a capacitor.

4. The integrated circuit module according to claim 1, wherein the at least one voltage converter of the plurality of voltage converters is at least one switching mode power converter.

5. The integrated circuit module according to claim 4, wherein the at least one switching mode power converter is at least one buck converter.

6. The integrated circuit module according to claim 1, wherein the at least one voltage converter of the plurality of voltage converters is at least one switching mode power converter comprising a galvanic separation between a primary stage and a secondary stage circuit of the at least one voltage converter.

7. The integrated circuit module according to claim 1, wherein the switching circuitry includes switching elements arranged in a two-dimensional matrix, the two-dimensional matrix comprising row conductors and column conductors, wherein the row conductors are connected to the input power supply rail and the column conductors are connected to the output power supply rail.

8. The integrated circuit module according to claim 1, wherein the switching circuitry includes switching elements arranged in a two-dimensional matrix, the two-dimensional matrix comprising row conductors and column conductors, wherein the row conductors are connected to the output power supply rail and the column conductors are conducted to the input power supply rail.

9. The integrated circuit module according to claim 1, wherein the integrated circuit module is a single chip module comprising a single semiconductor chip.

10. The integrated circuit module according to claim 1, wherein the integrated circuit module is a multi-chip module.

11. The integrated circuit module according to claim 1, wherein a primary stage of at least one voltage converter of the plurality of voltage converters is implemented as a half-bridge circuit.

12. The integrated circuit module according to claim 1, wherein a primary stage of at least one voltage converter of the plurality of voltage converters is implemented as a full-bridge circuit.

13. The integrated circuit module according to claim 1, wherein a secondary stage of at least one voltage converter of the plurality of voltage converters is implemented as a half-bridge circuit.

14. The integrated circuit module according to claim 1, wherein a secondary stage of at least one voltage converter of the plurality of voltage converters is implemented as a full-bridge circuit.
